(19) United States
(12) Patent Application Publication
(10) Pub. No.: US 2015/0066514 A1
(43) Pub. Date: Mar. 5, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Haisheng Dai, Beijing (CN)

(73) Assignees: Lenovo (Beijing) Co., Ltd., Beijing (CN); Beijing Lenovo Software Ltd., Beijing (CN)

(21) Appl. No.: 14/229,930

(22) Filed: Mar. 30, 2014

(30) Foreign Application Priority Data
Sep. 3, 2013 (CN) 201310394736.7

(51) Int. Cl. G06F 3/16; H04M 1/27; G06F 3/01; G10L 15/22; G10L 25/12

(52) U.S. Cl. CPC G06F 3/167; G10L 15/22; G10L 25/12; G06F 3/01; H04M 1/271; G10L 2015/223; G10L 2015/227; H04M 2250/74
USPC 704/275

(57) ABSTRACT

The disclosure discloses an information processing method and an electronic device, which relate to the field of electronic technologies, to improve a match degree between a recognition result of a voice recognition engine and a result required by the user and thus to improve the user experience. The electronic device includes N objects, each object corresponds to a weight value, and the weight value of each object is used to indicate a weight of the object in a search space of the voice recognition engine. The method provided by the disclosure includes: acquiring a first input operation; acquiring an execution object according to the first input operation; responding to the first input operation with the execution object; after the first input operation is responded to, determining L objects that have been displayed by the display unit in a first time period.

The present application claims the priority of Chinese Patent Application No. 201310394736.7, entitled as “Information processing method and electronic device”, and filed with the Chinese Patent Office on Sep. 3, 2013, the contents of which are incorporated herein by reference in its entirety.

### FIELD

The disclosure relates to the field of electronic technologies, and particularly to an information processing method and an electronic device.

### BACKGROUND

Different users may use different ways to find a target contact when dialing with a mobile phone. For example, some users are accustomed to directly find the target contact by voice; some users are accustomed to firstly browse a call log/address book and then select a target contact directly by means of a touch screen when the target contact is in the call log/address book, and find the target contact by voice only when the target contact is not in the call log/address book.

The voice input has strict requirements for the user, for example, whether the mandarin of the user is standard will affect the recognition result of a voice recognition engine, which will lead to a situation that the recognition result is not a result required by the user, thereby affecting the user experience.

### SUMMARY

Embodiments of the disclosure provide an information processing method and an electronic device, to improve a match degree between a recognition result of a voice recognition engine and a result required by a user, and thus to improve the user experience.

To achieve the above objects, the embodiments of the disclosure adopt the following technical solutions.

In a first aspect, there is provided an information processing method applied to an electronic device, the electronic device includes a display unit, a voice recognition engine and N objects, N≧1, the N is an integer, each object corresponds to a weight value, the weight value of each object is used to indicate a weight of the object in a search space of the voice recognition engine, the display unit displays thereon M objects, 1≦M<N, the M is an integer, the information processing method includes:

acquiring a first input operation;

acquiring an execution object according to the first input operation;

responding to the first input operation with the execution object;

after the first input operation is responded to, determining L objects that have been displayed by the display unit in a first time period, wherein M≦L≦N, the L is an integer, the first time period starts at a moment when the display unit displays thereon the M objects and ends at a moment when the first input operation is acquired;

determining an operation habit of a user at least according to a type of the first input operation; and

updating a collection composed of weight values of the N objects based on the operation habit of the user and the L.

In conjunction with the first aspect, in a first possible implementation way, the type of the first input operation is a voice input type, the information processing method further includes:

judging whether the execution object is one of the L objects;

the determining an operation habit of a user at least according to a type of the first input operation includes:

if the judgment result indicates that the execution object is one of the L objects, determining that the operation habit of the user is a voice input habit, according to the voice input type and the judgment result; or

if the judgment result indicates that the execution object is not one of the L objects, determining that the operation habit of the user is a non-voice input habit, according to the voice input type and the judgment result.

In conjunction with the first aspect, in a second possible implementation way, the type of the first input operation is a voice input type and the L is not equal to the M, the determining an operation habit of a user at least according to a type of the first input operation includes:

determining that the operation habit of the user is a non-voice input habit, according to the voice input type and the fact that the L is not equal to the M.

In conjunction with the first aspect, in a third possible implementation way, the type of the first input operation is a non-voice input type, the determining an operation habit of a user at least according to a type of the first input operation includes:

determining that the operation habit of the user is a non-voice input habit, according to the non-voice input type.

In conjunction with the first aspect, in a fourth possible implementation way, the operation habit of the user is a non-voice input habit, the updating a collection composed of weight values of the N objects based on the operation habit of the user and the L includes:

decreasing L weight values corresponding to the L objects.

In conjunction with the first aspect, in a fifth possible implementation way, the operation habit of the user is a voice input habit, the updating a collection composed of weight values of the N objects based on the operation habit of the user and the L includes:

increasing L weight values corresponding to the L objects in the case that the N objects are objects that are frequently used.

In a second aspect, there is provided an information processing method applied to an electronic device, the electronic device includes a voice recognition engine, the electronic device have N objects, the N is an integer greater than or equal to 1, the information processing method includes:

acquiring a first input operation, wherein the first input operation involves M objects, the M is an integer greater than or equal to 1 and less than N;

responding to the first input operation based on the M objects;

acquiring a triggering operation;

switching the voice recognition engine from a low power consumption state to an operating state based on the triggering operation;

acquiring a voice input; and

recognizing the voice input based on the voice recognition engine to obtain a recognition result,

wherein in the process of recognizing the voice input based on the voice recognition engine, the remaining N-M objects are recognized and matched with the voice input taking precedence over the M objects.

In a third aspect, there is provided an electronic device, the electronic device includes a display unit, a voice recognition engine and N objects, N≧1, the N is an integer, each object corresponds to a weight value, the weight value of each object is used to indicate a weight of the object in a search space of the voice recognition engine, the display unit displays thereon M objects, 1≦M<N, the M is an integer, the electronic device includes:

a first acquisition unit, configured to acquire a first input operation;

a second acquisition unit, configured to acquire an execution object according to the first input operation;

a response unit, configured to respond to the first input operation with the execution object;

a history object determination unit, configured to, after the first input operation is responded to, determine L objects that have been displayed by the display unit in a first time period, wherein M≦L≦N, the L is an integer, the first time period starts at a moment when the display unit displays thereon the M objects and ends at a moment when the first input operation is acquired;

a user operation habit determination unit, configured to determine an operation habit of a user at least according to a type of the first input operation; and

an updating unit, configured to update a collection composed of weight values of the N objects based on the operation habit of the user and the L.

In conjunction with the third aspect, in a first possible implementation way, the type of the first input operation is a voice input type, the electronic device further includes:

a judgment unit, configured to judge whether the execution object is one of the L objects,

the user operation habit determination unit is configured to:

if the judgment result indicates that the execution object is one of the L objects, determine that the operation habit of the user is a voice input habit according to the voice input type and the judgment result; or

if the judgment result indicates that the execution object is not one of the L objects, determine that the operation habit of the user is a non-voice input habit according to the voice input type and the judgment result.

In conjunction with the third aspect, in a second possible implementation way, the type of the first input operation is a voice input type and the L is not equal to the M,

the user operation habit determination unit is configured to determine that the operation habit of the user is a non-voice input habit according to the voice input type and the fact that the L is not equal to the M.

In conjunction with the third aspect, in a third possible implementation way, the type of the first input operation is a non-voice input type,

the user operation habit determination unit is configured to determine that the operation habit of the user is a non-voice input habit according to the non-voice input type.

In conjunction with the third aspect, in a fourth possible implementation way, the operation habit of the user is a non-voice input habit, the updating unit is configured to decrease L weight values corresponding to the L objects.

In conjunction with the third aspect, in a fifth possible implementation way, the operation habit of the user is a voice input habit, the updating unit is configured to increase L weight values corresponding to the L objects in the case that the N objects are objects that are frequently used.

In a fourth aspect, there is provided an electronic device, the electronic device includes a voice recognition engine, the electronic device has N objects, the N is an integer greater than or equal to 1, the electronic device further includes:

a first acquisition unit, configured to acquire a first input operation, wherein the first input operation involves M objects, the M is an integer greater than or equal to 1 and less than N;

a response unit, configured to respond to the first input operation with the M objects;

a second acquisition unit, configured to acquire a triggering operation;

a switching unit, configured to switch the voice recognition engine from a low power consumption state to an operating state based on the triggering operation;

a third acquisition unit, configured to acquire a voice input; and

a recognition unit, configured to recognize the voice input based on the voice recognition engine to obtain a recognition result,

where in the process of recognizing the voice input based on the voice recognition engine, the remaining N-M objects are recognized and matched with the voice input taking precedence over the M objects.

According to the information processing method and the electronic device provided by the disclosure, the electronic device includes N objects and displays thereon M objects; after the first input operation is responded to with the execution object, the operation habit of the user is determined at least according to the type of the first input operation, and the collection composed of weight values of N objects is updated based on the operation habit of the user and the L, wherein L is the number of objects displayed on the display unit from the moment when the display unit displays thereon M objects to the moment when the first input operation is acquired. The updated collection may be used in the process of finding the execution object by a voice input operation the next time, thus improving a match degree between a recognition result of a voice recognition engine and a result required by the user, and thus improving the user experience.

### BRIEF DESCRIPTION OF THE DRAWINGS

FIG. 1 is a flowchart of an information processing method according to an embodiment of the disclosure;

FIG. 2 is a flowchart of another information processing method according to an embodiment of the disclosure;

FIG. 3 is a flowchart of another information processing method according to an embodiment of the disclosure;

FIG. 4 is a flowchart of another information processing method according to an embodiment of the disclosure;

FIG. 5 is a flowchart of another information processing method according to an embodiment of the disclosure;

FIG. 6 is a flowchart of another information processing method according to an embodiment of the disclosure;

FIG. 7 is a schematic structural diagram of an electronic device according to an embodiment of the disclosure;

FIG. 8 is a schematic structural diagram of another electronic device according to an embodiment of the disclosure;

FIG. 9 is a schematic structural diagram of another electronic device according to an embodiment of the disclosure; and

FIG. 10 is a schematic structural diagram of another electronic device according to an embodiment of the disclosure.

### DETAILED DESCRIPTION

In the following the technical solution in the disclosure will be described clearly and completely in connection with accompanying drawings in the embodiments of the disclosure. It is obvious that the embodiments described are only a part of the embodiments of the disclosure, not all the embodiments. All the other embodiments based on the embodiments of the disclosure obtained by the skilled in the art without creative works fall with in the protective scope of the disclosure.

In addition, terms “system” and “network” in the disclosure may always be exchanged herein. The term “and/or” herein is only an associated relationship for describing associated objects, which represents that there may be three relationships. For example, A and/or B may represents the three cases of existing A alone, existing A and B simultaneously and existing B alone. In addition, the symbol “/” herein generally represents that the associated relationship of the associated objects is “or”.

### First Embodiment

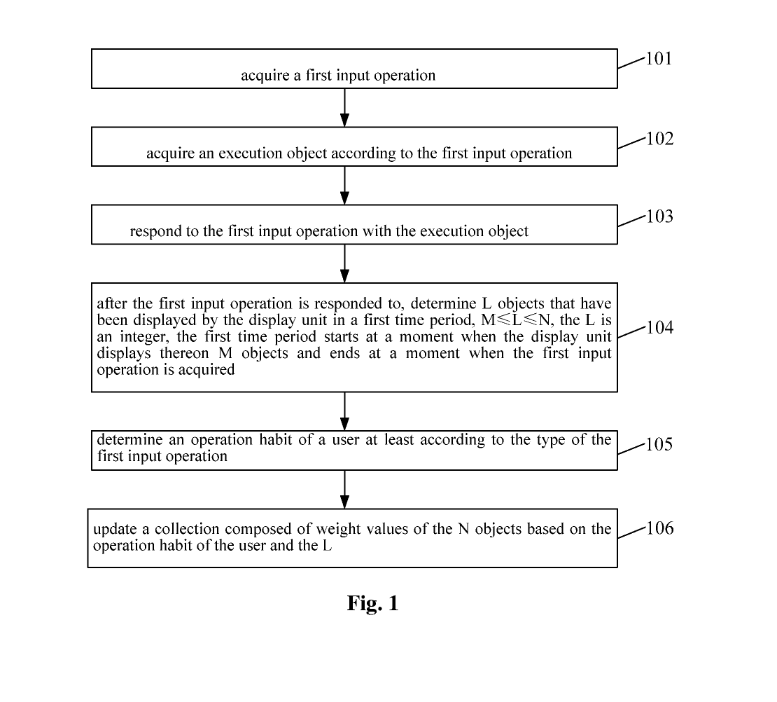

Referring to FIG. 1, an information processing method applied to an electronic device according to an embodiment of the disclosure is provided. The electronic device includes a display unit, a voice recognition engine and N objects, where N≧1, and the N is an integer. Each object corresponds to one weight value, and the weight value of each object indicates a weight of this object in a search space of the voice recognition engine. M objects are displayed on the display unit, where 1≦M<N, and the M is an integer. The method includes:

Step 101: acquiring a first input operation.

Specifically, the electronic device may be a smartphone, a table computer or the like.

The object may be a shortcut of an application, a phone number, a name or the like in the electronic device. The N objects may be shortcuts of all the application in the electronic device, or all applications in a collection composed of applications that are frequently used, or all phone numbers/names in a call log, or all phone numbers/names in the call log and an address book, or the like.

The first input operation may be a voice input operation or a non-voice input operation indicated by the user. Specifically, the non-voice input operation may be a select operation (a single-click select, a double-click select or the like), may also be achieved by a way such as a touch screen or a key pressing.

Step 102: acquiring an execution object according to the first input operation.

Specifically, the acquiring the execution object according to the first input operation is to search an object matched with this first input operation in the N objects and taking the found result as the execution object. This execution object is an object selected by the first input operation. For example, when the first input operation is “call x x”, Step 102 may be to search this “x x” in the address book and/or the call log. As another example, when the first input operation is “select a map application”, Step 102 may be to find the map application in the applications.

A process of acquiring the execution object by the electronic device may generally include several cases as follows:

Case 1: directly receiving a voice input operation (a first input operation) indicated by the user, and thus acquiring an execution object according to this voice input operation.

Case 2: directly receiving a non-voice input operation (a first input operation) indicated by the user, and thus acquiring an execution object according to this non-voice input operation.

Specifically, the non-voice input operation here is a select operation. Optionally, before receiving the select operation (a first operation), the non-voice input operation may further include receiving a non-voice input operation such as a browse operation or an operation of clicking a pull-down menu.

Case 3: firstly receiving a non-voice input operation indicated by the user, the non-voice input operation indicated by the user is responded through updating an object displayed on the display unit; then receiving a voice input operation indicated by the user, and thus an execution object is acquired according to the voice input operation.

Specifically, the non-voice input operation here is generally an operation such as a browse operation or an operation of clicking a pull-down menu. This case may be: when the user does not find the desired object (an execution object) in the case of a non-voice input operation, then the user searches the desired object (an execution object) through a voice input operation.

Exemplarily, the browse operation may be implemented as follows: when a slide touch operation is performed by the user, M objects are displayed on each display unit, at least one object among the two collections of the objects (each collection has M objects) respectively displayed on the display unit before and after the swipe touch operation is different. The operation of clicking a pull-down menu may be implemented as follows: when the operation of clicking a pull-down menu is performed by the user, k objects is added to the objects displayed on the display unit on the basis of the original M objects, where the k is an integer greater than or equal to 1.

Step 103: responding to the first input operation with an execution object.

Exemplarily, when the first input operation is “call x x”, Step 102 may be to search this x x in the address book and/or the call log, and this Step 103 may be to call this x x. As another example, when the first input operation is “select a map application”, Step 102 may be to search the map application in the applications, this Step 103 may be to start the map application.

Step 104: after the first input operation is responded to, determining L objects which have been displayed on the display unit during a first time period, where M≦L≦N, and the L is an integer. The first time period refers to a time period from a moment when the M objects are displayed on the display unit to a moment when the first input operation is acquired.

Specifically, the electronic device may display a part not displayed or all objects of the N objects on the display unit through an browse operation or an operation of clicking a pull-down menu performed by the user, and thus it is convenient for the user to search the desired object (an execution object).

The L objects which have been displayed on the display unit during the first time period including such two cases:

1) L=M, this case indicates that an non-voice input operation such as a browse operation or an operation of clicking an pull down menu is not received before the first input operation is received.

2) M<L≦N, this case indicates that an non-voice input operation such as a browse operation or an operation of clicking an pull down menu has been received before the first input operation is received.

Step 105: determining an operation habit of the user at least according to a type of the first input operation.

Specifically, the type of the first input operation may be divided to a voice input type and a non-voice input type. The electronic device may acknowledge and record the type of the first input operation. For example, if a voice recognition engine is used during the process that acquiring the execution object in Step 102, the type of the first input operation is determined as a voice input type. The embodiments of the disclosure do not limit the method employed by the electronic device to learn the type of the first input operation.

The operation habit of the user may further include a voice input habit and a non-voice input habit.

Optionally, the type of the first input operation is a voice input type, the method further includes judging whether the execution object is one of the L objects.

In this case, Step 105 may be as follows:

if the judgment result indicates that the execution object is one of the L objects, determining that the operation habit of the user is a voice input habit, according to the voice input type and the judgment result; or

if the judgment result indicates that the execution object is not one of the L objects, determining that the operation habit of the user is a non-voice input habit, according to the voice input type and the judgment result.

Optionally, the type of the first input operation is a voice input type, L is not equal to M; in this case, Step 105 may be as follows:

determining that the operation habit of the user is a voice input habit, according to the voice input type and the fact that the L is not equal to the M.

Optionally, the type of the first input operation is a non-voice input type; in this case, Step 105 may be as follows: determining that the operation habit of the user is the non-voice input habit according to the non-voice input type. Specifically, this case corresponds to 2) in Step 102.

Step 106: updating a collection composed of weight values of the N objects based on the operation habit of the user and the L.

Exemplarily, the collection composed of weight values corresponding to the N objects is updated by the method of updating the weight values corresponding to one or more of the N objects. Particularly, the collection composed of weight values corresponding to the N objects may be undated by the method of updating the weight values corresponding to the L objects.

Optionally, the operation habit of the user is the non-voice input habit. In this case, Step 106 may include decreasing the L weight values corresponding to the L objects.

Optionally, the operation habit of the user is a voice input habit. In this case, Step 106 may include increasing the L weight values corresponding to the L objects in the case that the N objects are objects that are frequently used.

It is necessary to explain that the electronic device updates the collection composed of the weight values corresponding to the N objects each time after the first input operation is responded to with the execution object; and when the voice input operation is received again, a next execution object is obtained by matching according to the weight values corresponding to each object of the updated collection and the voice input operation. Particularly, the electronic device matches the voice input operation with the object in the search space of the voice recognition engine after the voice input operation is received. Specifically, during the process of matching one object, the weight value of the object is increased, and thus obtaining the final match result. In other words, a final match result of one object with the voice input operation is codetermined by the match degree of the object and the voice input operation and the corresponding weight value of the object.

The embodiment of the disclosure provides an information processing method applied to an electronic device. The electronic device includes N objects, and M objects are displayed on the display unit. The electronic device determines the operation habit of the user at least according to the type of the first input operation, and updates the collection composed of the weight values corresponding to the N objects according to the operation habit of the user and the L, after the first input operation is responded to with an execution object. Specifically, L refers to the number of the objects which have been displayed on the display unit from a moment when the M objects are displayed on the display unit to a moment when the first input operation is acquired. The updated collection may be applied in the next process of searching an execution object through the voice input operation, and thus improving the match degree of the recognition result of the voice recognition engine and the result desired by the user, enhancing the user experience.

### Second Embodiment

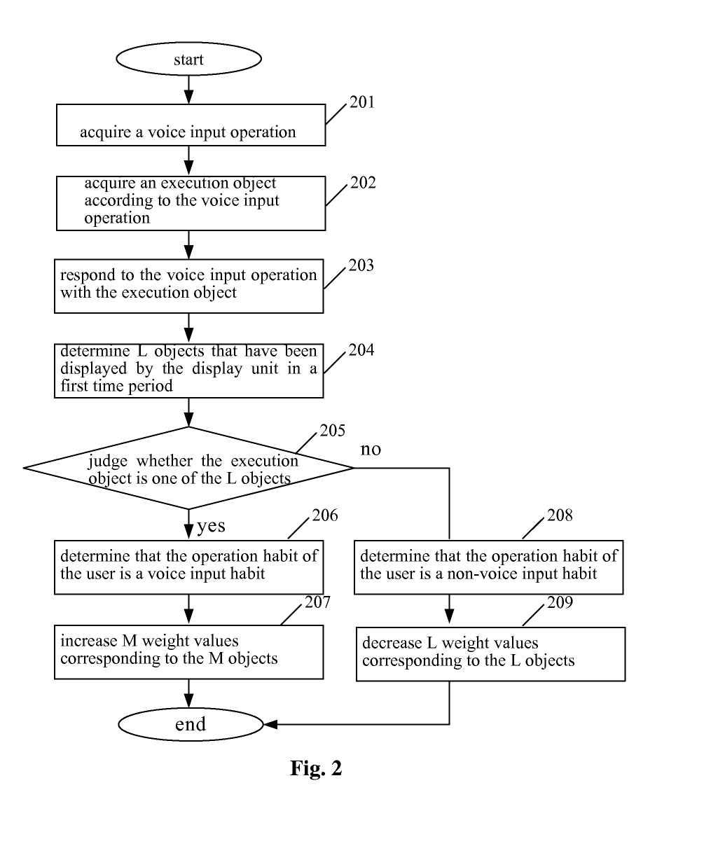

Referring to FIG. 2, the embodiment of the present disclosure provides an information processing method applied to an electronic device. The device includes a display unit, a voice recognition engine and N objects, N>1, and the N is an integer. Each object corresponds to a weight value, and the weight value of each object is used to indicate the weight of the object in a search space of the voice recognition engine. The display unit displays thereon M objects, 1≦M<N, and M is an integer. The method includes the following steps S201 to S209.

Step 201, acquiring a voice input operation.

Exemplarily, in practice, before the voice input operation is acquired, the method may further include receiving an operation information for determining N objects indicated by a user, such as, an operation information for opening a regular contact list indicated by the user, an operation information for opening a call record, an operation information for opening an list composed of applications used frequently or the like. The embodiment will be described by taking the receiving an operation information for opening the regular contact list indicated by the user as an example, that is, the N objects are the regular contacts.

Specifically, the regular contacts may be set by the user, or may be determined by analyzing recent call records of the user by the electronic device. Specifically, the latter may be achieved as follows. The regular contacts are determined by analyzing a call frequency and a call time of the user with each contact recently by the electric device, and these regular contacts are sequenced. The M objects in the front are displayed on the display unit.

Step 202, acquiring an execution object according to the voice input operation.

Exemplarily, it may be seen from the description of the step 102 according to the first embodiment that the process for acquiring the execution object by the electric device according to this embodiment may includes case 1 and case 3.

Step 203, responding to the voice input operation with the execution object.

Exemplarily, when the voice input operation is to “call xx ”, the specific step 202 is to find xx in the regular contacts, and the specific step 203 may be to dial a phone number of xx.

Step 204, determining L objects that have been displayed by the display unit in a first time period, wherein the first time period starts at a moment when the display unit displays thereon the M objects and ends at a moment when the first input operation is acquired.

The L objects displayed on the display unit in the first time period include two cases.

1) L=M, this case shown that before the voice input operation is received, no non-voice input operations of a browse operation, an operation of clicking on a drop-down menu or the like are received, which is corresponding to the case 1.

2) M<L≦N, this case shown that before the voice input operation is received, non-voice input operations of a browse operation, an operation of clicking on a drop-down menu or the like are received, which is corresponding to the case 3.

Step 205, judging whether the execution object is one of the L objects.

If the execution object is one of the L objects, step 206 is performed; if the execution object is not one of the L objects, step 208 is performed.

Step 206, determining that an operation habit of the user is a voice input habit.

Exemplarily, this case shows that the execution object has been displayed on the display unit in the first time period, however the user is still searching for a required object (a execution object) in a manner of a voice input. Therefore, it may be inferred that the user is not accustomed to the non-voice operation, that is, the operation habit of the user is the voice input habit.

Step 207, increasing M weight values corresponding to the M objects.

After the step 207 has been completed, the process is end.

In this case, since the operation habit of the user is the voice input habit, that is, no non-voice input operations of a browse operation, an operation of clicking on a drop-down menu or the like are indicated by the user before indicating the voice input operation, and the L is equal to the M.

Since the N objects are the regular contacts, and the M objects used most commonly are displayed on the display unit, the required object (the execution object) has a larger probability to be one of M objects at each time when the user makes a call. Thus the weight values corresponding to M objects may be increased. When the voice input operation is received next time, the M weight values after the weight value has been increased may be respectively applied to a matching process of the M objects with the voice input operation, and then a final match result is acquired. Thereby priorities of the M objects in the recognition result of the voice recognition engine are increased, and a matching degree of the recognition result between the voice recognition engine and the required result of the user is improved, and the user's experience is improved.

Step 208, determining that the operation habit of the user is a non-voice input habit.

Exemplarily, this case shows that the execution object is not displayed on the display unit in the first time period. It can be considered that the objects displayed on the display unit are browsed by the user, but the required object (the execution object) is not found. Thus it is found in a manner of the voice input, that is, it may be considered that the operation habit of the user is the non-voice input habit.

Step 209, decreasing L weight values corresponding to the L objects.

After the step 209 has been completed, the process is end.

Exemplarily, since the operation habit of the user is the non-voice input habit, the user may find directly the required object (the execution object) according to the L objects displayed on the display unit. In the case where the required object (the execution object) is not found, the voice input operation is used. That is, in the case where the required objects is acquired by the voice input operation, priorities of the L objects in the recognition result of the voice recognition engine are not high. Thus, the L weight values corresponding to the L objects may be reduced. When the voice input operation is received next time, the L weight values after the weight value has been reduced may be respectively applied to the matching process of the L objects with the voice input operation, and then a final match result is acquired. Thereby the priorities of the L objects in the recognition result of the voice recognition engine are reduced, and the matching degree of the recognition result between the voice recognition engine and the required result of the user is improved, and the user's experience is improved.

It should be noted that the method for updating the weight value and the updating amount in the step 207 and step 209 according to this embodiment is no limitation. For example, in order to reduce the case that the inaccurate judgment to the operation habits of the users due to a misoperation of the user, the weight values corresponding to the objects may be updated in a manner of an incremental weighting. The updating amount of the weight value corresponding to one object may be determined by a call frequency and a call time between the user with the object or the like.

Exemplarily, assuming that N objects includes: object 1, object 2, and object 6, and an initial weight value of each object is zero. The M objects includes: object 1, object 2, object 3, and object 4, and the weight values of the M objects are respectively 0.1, 0.3, 0.2,0.2 after the step 207 has been performed. And when a voice input operation is received next time, assuming that matching degrees between the N objects and the voice input operations are respectively 0.35, 0.8, 0.1, 0.2, 0.9, and 0.1, after the weight value has been increased during the matching process, the final match results are respectively 0.45, 1.1, 0.3, 0.4, 0.9 and 0.1.

The object with the largest match result (object 2) is regarded as the execution object by the electronic device. Furthermore, when a voice input operation is received another time, the weight values of N objects used in the matching process may be respectively 0.1, 0.3, 0.2, 0.2, 0, and 0.

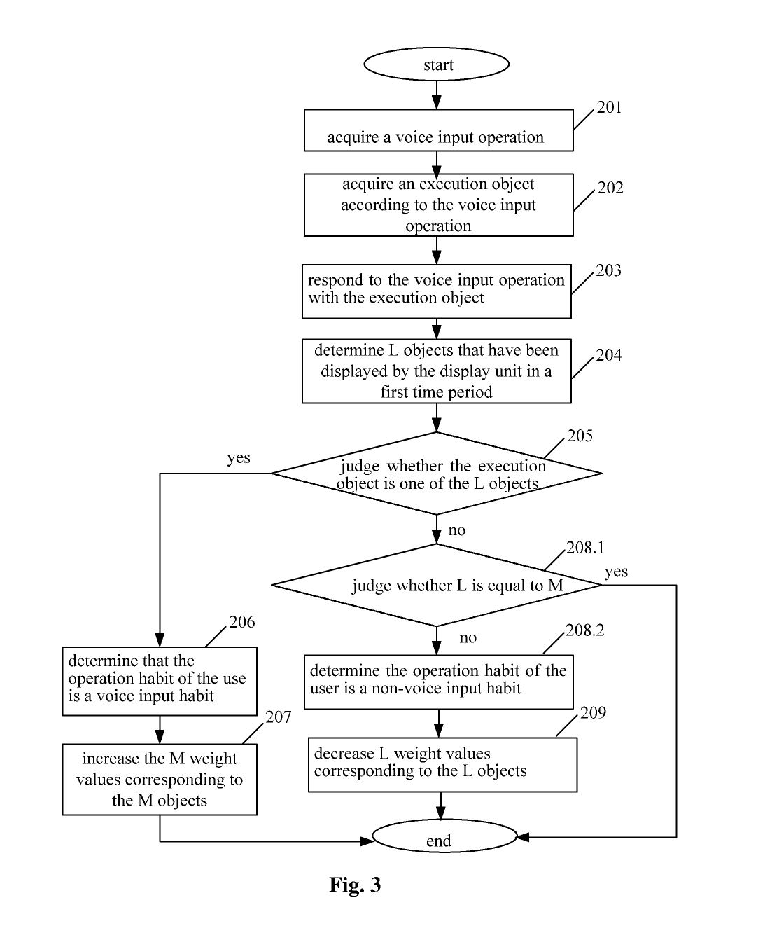

Optionally, referring to FIG. 3, step 208 may also be replaced with step 208.1 to step 208.2.

Step 208.1, judging whether the L is equal to the M.

If the L is not equal to the M, step 208.2 is performed. If the L is equal to the M, the process is end.

It should be noted that if the L is equal to the M, there may be the following scenario. The user does not browse the objects displayed on the display unit at all, that is, it may be considered that the user is not accustomed to the non-voice operation. It may be seen that, in this case, the operation habit of the user is difficult to judge. In practice, a collection composed of the weight values corresponding to N objects may not be updated in this case, and the weight value corresponding to the execution object may also be increased.

Step 208.2, determining that the operation habit of the user is a non-voice input habit.

This case shows that M<L≦N, that is, non-voice input operations of a browse operation, an operation of clicking on a drop-down menu or the like are received before an voice input operation is received in step 201. And it may be determined that the operation habit of the user is the non-voice input habit.

Step 209 is performed after the step 208.2 has been performed.

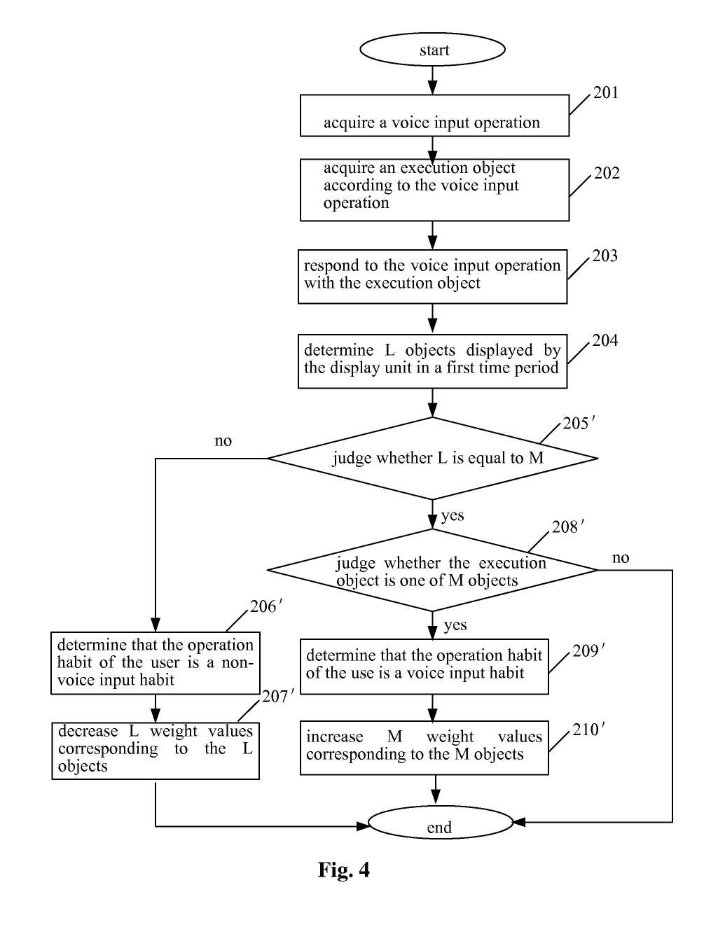

Optionally, referring to FIG. 4, step 205 to step 209 may also be replaced with step 205′ to step 210′.

Step 205′, judging whether the L is equal to the M.

If the L is not equal to the M, step 206′ is performed. If the L is equal to the M, step 208′ is performed.

Step 206′, determining that the operation habit of the user is a non-voice input habit.

Exemplarily, this case shows that M<L≦N, that is, non-voice input operations of a browse operation, an operation of clicking on a drop-down menu or the like are received before an voice input operation is received in step 201. And it may be determined that the operation habit of the user is the non-voice input habit. Furthermore, since he does not find the required object (the execution object) in a manner of the non-voice input, the user finds further the required object (the execution object) in a manner of a voice input operation.

Step 205′ to step 206′ are the same as step 208.1 to step 208.2.

Step 207′, decreasing L weight values corresponding to the L objects.

Step 208′, judging whether the execution object is one of M objects.

If the execution object is one of M objects, step 209′ is performed. If the execution object is not one of M objects, the process is end.

Step 209′, determining that the operation habit of the user is a voice input habit.

Step 210′, increasing M weight values corresponding to the M objects.

The embodiment of the present disclosure provides an information processing method applied to an electronic device. With the electronic device, after the execution object has been responded to with the voice input operation, the operation habit of the user is determined by judging whether the execution object is one of the L objects displayed on the display unit in the first time period or judging by comparing M with L, where M refers to the number of the objects displayed on the display unit, and L refers to the number of the objects displayed on the display unit during a time period that starts at a moment when the display unit displays thereon the M objects and ends at a moment when the first input operation is acquired. If it is determined that the operation habit of the user is a voice input habit, the M weight values corresponding to the M objects are increased. If it is determined that the operation habit of the user is a non-voice input habit, the L weight values corresponding to the L objects is decreased. The updated weight values may be applied to the process of finding the execution object in a manner of the voice input operation, thus a matching degree of the recognition result between the voice recognition engine and the required result of the user is improved, and the user's experience is improved.

### Third Embodiment

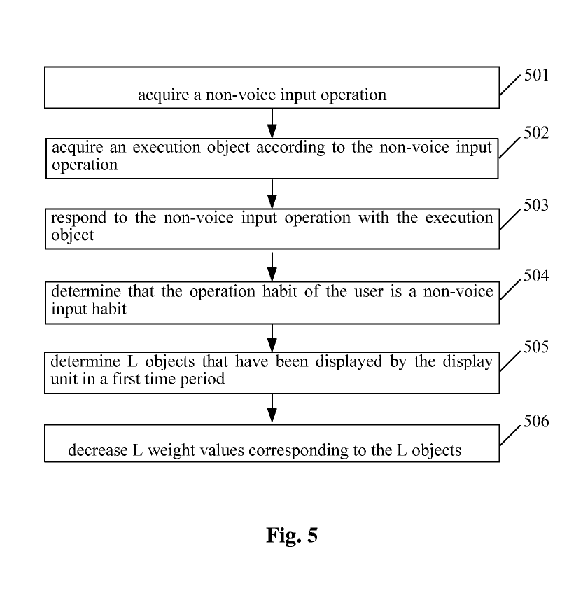

Referring to FIG. 5, the embodiment of the present disclosure provides an information processing method applied to an electronic device. The device includes a display unit, a voice recognition engine and N objects, N≧1, and the N is an integer. Each object corresponds to a weight value, and the weight value of each object is used to indicate the weight of the object in a search space of the voice recognition engine. The display unit displays thereon M objects, 1≦M<N, and M is an integer. The method includes the following steps S501 to S505.

Step 501, acquiring a non-voice input operation.

Step 502, acquiring an execution object according to the non-voice input operation.

Exemplarily, it may be seen from the description of the step 102 according to the first embodiment that the process for acquiring the execution object by the electric device may be the case 2.

Step 503, responding to the non-voice input operation with the execution object.

Exemplarily, when the non-voice input operation is to “call xx ”, the specific step 502 is to find xx in a phone book or a call history, and the specific step 503 may be dial a phone number of xx. For another example, when a first input operation is to “select a map application”, the specific step 502 is to find a map application among the applications, the specific step 503 may be to start the map application.

Step 504, determining that an operation habit of a user is a non-voice input habit.

Exemplarily, since the operation acquired in the step 501 is a non-voice input operation, it may be judged that the operation habit of the user is the non-voice input habit.

Step 505, determining L objects that have been displayed by the display unit in a first time period, wherein the first time period starts at a moment when the display unit displays thereon the M objects and ends at a moment when the first input operation is acquired.

Step 504 and step 505 may be exchanged in their execution order.

Step 506, decreasing L weight values corresponding to the L objects.

Optionally, if the step 504 is performed after the step 505 has been performed, the step 504 may be replaced with the following step. It is judged whether the L is equal to the M. If the L is not equal to the M, it is determined that the operation habit of the user is a habit of clicking on a drop-down menu/browse in the non-voice input habit. If the L is equal to the M, it can not be determined whether the operation habit of the user is a habit of clicking on a drop-down menu/browse, however it may be determined that the operation habit of the user is a non-voice input habit.

Exemplarily, since the operation habit of the user is the non-voice input habit, the user may find directly a required object (an execution object) according to the L objects displayed on the display unit. That is, in the case where the required object (the execution object) is acquired by the voice input operation for the next time, priorities of the L objects in the recognition result of the voice recognition engine are not high. Thus, the L weight values corresponding to the L objects may be reduced. When the voice input operation is received the next time, the L weight values after the weight value has been reduced may be respectively applied to the matching process of the L objects with the voice input operation, and then a final match result is acquired. Thereby the priorities of the L objects in the recognition result of the voice recognition engine are reduced, and the matching degree of the recognition result between the voice recognition engine and the required result of the user is improved, and the user's experience is improved.

The embodiment of the present disclosure provides an information processing method applied to an electronic device. With the electronic device, after the execution object has been responded to with the voice input operation, it is determined that the operation habit of the user is the non-voice operation habit and the L weight values corresponding to the L objects are decreased, where the first time period starts at a moment when the display unit displays thereon the M objects and ends at a moment when the first input operation is acquired. The updated weight values may be applied to the process of finding the execution object in a manner of the voice input operation the next time, thus a matching degree of the recognition result between the voice recognition engine and the required result of the user is improved, and the user's experience is improved.

### Fourth Embodiment

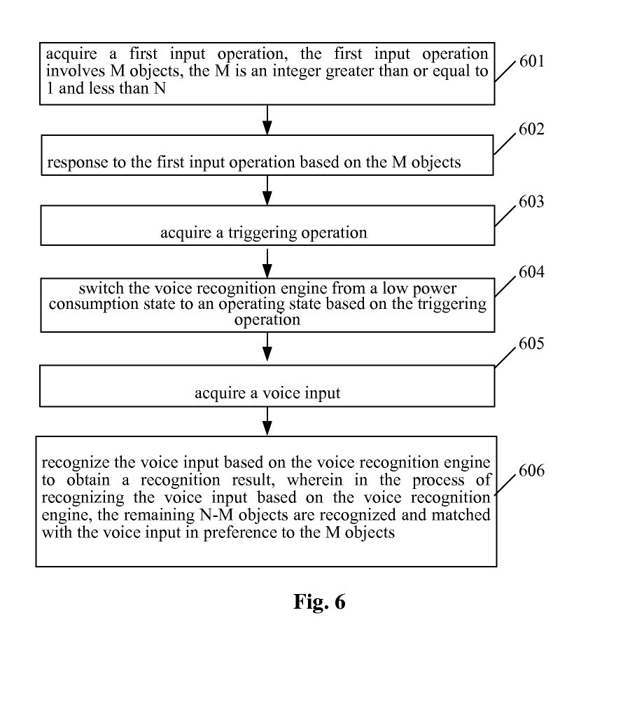

Referring to FIG. 6, the embodiment of the present disclosure provides an information processing method applied to an electronic device. The device includes a voice recognition engine and N objects, and the N is an integer greater than or equal to 1. The method includes the following steps S601 to S606.

Step 601, acquiring a first input operation, wherein the first input operation involves M objects, the M is an integer greater than or equal to 1 and less than N.

Specifically, the electric device may be a smartphone, a tablet PC or the like.

The object may be a shortcut of one application program, a phone number, a name or the like in the electric device. N objects may be shortcuts of all applications in the electric device, all applications in a collection composed of applications used frequently, all phone numbers/names in a call record, or all phone numbers/names in the call record and the phone book.

The first input operation may be a browse operation, an operation of clicking on a drop-down menu, an operation of clicking on a call application or the like.

The electric device may include a display unit, the display unit displays thereon T objects, and the T is an integer greater than or equal to 1.

In the case where the first input operation is a browse operation/an operation of clicking on a drop-down menu, the T objects displayed on the display unit are updated. The M objects involved in the first input operation may be the updated T objects on the display unit. Specifically, in the case where the first input operation is a browse operation, at least one of two group objects displayed on the display unit are different before or after the first input operation has been acquired. In the case where the first input operation is an operation of clicking on a drop-down menu, an updating for the T objects displayed on the display unit is specifically to add k objects to T objects, where k is an integer greater than or equal to 1.

In the case where the first input operation is an operation of clicking on a call application, the M objects involved in the first input operation may be an object displayed on the display unit at a current moment, specifically may be a portion of contacts in the phone book, or a portion of contacts in the history record.

Step 602, responding to the first input operation based on the M objects.

Specifically, the display unit displays thereon M objects, or, the user is prompted in a manner of a voice, so that the user learns about M objects.

Step 603, acquiring a triggering operation.

Step 604, switching the voice recognition engine from a low power consumption state to an operating state based on the triggering operation.

Specifically, the low power consumption state may include an off state and a sleep state; a normal operating state may include a receiving voice state, a processing state, a displaying result state or the like. The electronic device in the normal operating state may be specifically as follows: firstly entering the receiving voice state adapted to receive a voice input; entering the processing state adapted to analysis and process the received input after the voice input has been received; and entering the displaying result state adapted to display a processing result after the processing has been completed.

To save electricity, the electronic device is generally in the low power state, and the electronic device will enter the normal operating state only when a specific trigger condition is met. The trigger condition according to the embodiment of the present disclosure is a triggering operation, and specifically may be a click operation, a double-click operation, a long button operation or the like.

Step 605, acquiring a voice input.

Step 606, recognizing the voice input based on the voice recognition engine to obtain a recognition result, wherein in the process of recognizing the voice input based on the voice recognition engine, the remaining N-M objects are recognized and matched with the voice input taking precedence over the M objects.

Exemplarily, the weight value corresponding of the remaining N-M objects may be increased or may be decreased, so that when the voice recognition engine finds an object matched with the voice input, an object with greater weight value is preferably matched. Thus a match result is acquired quickly and displayed to the user. Thereby the user's experience is improved.

The embodiment of the present disclosure provides an information processing method applied to an electronic device. The device includes a display unit, a voice recognition engine and N objects. The first input operation is acquired; the first input operation is responded to with the M objects; and after the voice input has been acquired, the voice input is recognized based on the voice recognition engine to obtain a recognition result, wherein in the process of recognizing the voice input based on the voice recognition engine, the remaining N-M objects are recognized and matched with the voice input taking precedence over the M objects. The first input operation is responded to with the M objects, so that the user learns about M objects. The user performs further a voice input based on learning about the M objects, which shows that the object required by the user is not in the M objects. Therefore, the object required by the user is in the remaining N-M objects. Thus the objects that the user does not learn about are recognized and matched with the voice input taking precedence over the objects that the user has been learned about. The recognition result may be acquired quickly, and the user's experience is improved.

### Fifth Embodiment

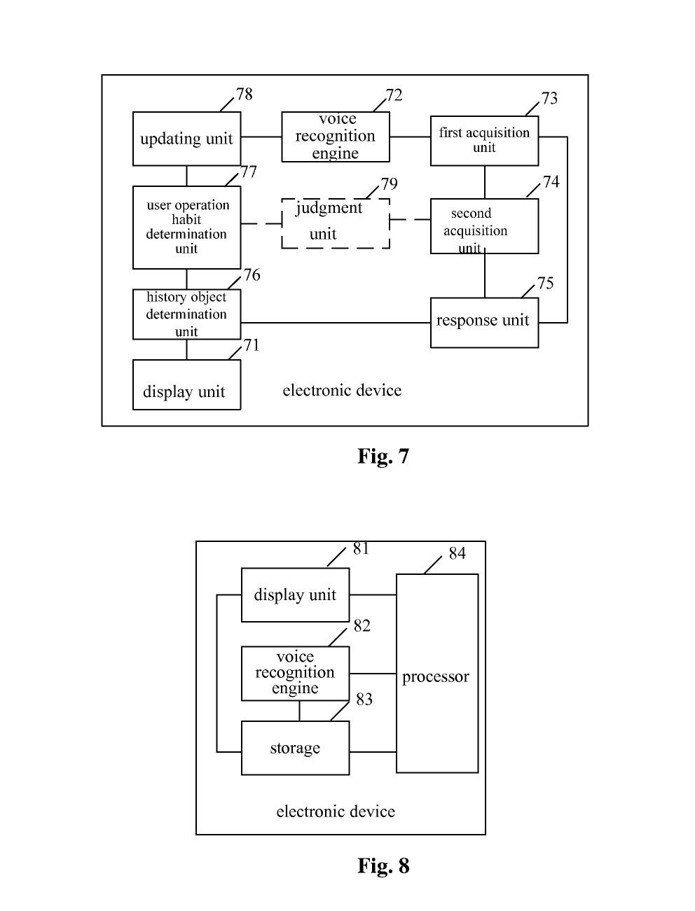

Referring to FIG. 7, an electronic device is provided according to the embodiment of the disclosure to perform a method for processing information shown in FIG. 1, the electronic device includes a display unit 71, an voice recognition engine 72 and N objects, wherein N≧1, and N is an integer, each object corresponds to a weight value, the weight value of each object is used to indicate a weight of the object in a search space of the voice recognition engine 72, and the display unit 71 displays thereon M objects, 1≦M<N, the M is an integer, the electronic device also includes:

a first acquisition unit 73, configured to acquire a first input operation;

a second acquisition unit 74, configured to acquire an execution object according to the first input operation;

a response unit 75, configured to respond to the first input operation with the execution object;

a history object determination unit 76, configured to, after the first input operation is responded to, determine L objects that have been displayed by the display unit 71 in a first time period, wherein M≦L≦N, the L is an integer, the first time period starts at a moment when the display unit 71 displays thereon the M objects and ends at a moment when the first input operation is acquired;

a user operation habit determination unit 77, configured to determine an operation habit of a user at least according to a type of the first input operation;

an updating unit 78, configured to update a collection composed of weight values of the N objects based on the operation habit of the user and the L.

Alternatively, the type of the first input operation is a voice input type, and the electronic device also includes:

a judgment unit 79, configured to judge whether the execution object is one of the L objects;

The user operation habit determination unit 77 is particularly configured to:

if the judgment result is yes, determine that operation habit of the user is a voice input habit according to the voice input type and the judgment result;

or, if the judgment result is no, determine that operation habit of the user is a non-voice input habit according to the voice input type and the judgment result.

Alternatively, the type of the first input operation is a voice input type, and the L is not equal to the M.

The user operation habit determination unit 77 is particularly configured to determine that the operation habit of the user is a non-voice input habit according to the voice input type and the fact that the L is not equal to the M.

Alternatively, the type of the first input operation is a non-voice input type;

The user operation habit determination unit 77 is particularly configured to determine that user operation habit is the non-voice input habit according to the non-voice input type.

Alternatively, if the operation habit of the user is a non-voice input habit, the update unit 78 is particularly configured to decrease the L weight values corresponding to the L objects.

Alternatively, if the operation habit of the user is a voice input habit, the update unit 78 is particularly configured to increase the L weight values corresponding to the L objects in the case the N objects are objects that are frequently used.

According to the information processing method and the electronic device provided by the disclosure, the electronic device includes N objects and displays thereon M objects; after the first input operation is responded to with the execution object, the operation habit of the user is determined at least according to the type of the first input operation, and the collection composed of weight values of N objects is updated based on the operation habit of the user and the L, wherein L is the number of objects displayed on the display unit from the moment when the display unit displays thereon M objects to the moment when the first input operation is acquired. The updated collection may be used in the process of finding the execution object by a voice input operation the next time, thus improving a match degree between a recognition result of a voice recognition engine and a result required by the user, and thus improving the user experience.

### Sixth Embodiment

Referring to FIG. 8, an electronic device is provided according to the embodiment of the disclosure to execute a method for processing information shown in FIG. 1, the electronic device includes a display unit 81, an voice recognition engine 82 and N objects, wherein N≧1, and N is an integer, each object corresponds to a weight value, the weight of each object is used to indicate the weight of the object in a search space of the voice recognition engine 82, and the display unit 81 displays thereon M objects, 1≦M<N, the M is an integer, the electronic device also includes a storage 83 and a processor 84, wherein

the storage 83 is configured to store a set of code which is used to control the processor 84 to perform the following actions:

acquire a first input operation;

acquire an execution object according to the first input operation ;

respond to the first input operation with the execution object;

after the first input operation is responded to, determine L objects that have been displayed by the display unit in a first time period, wherein M≦L≦N, the L is an integer, the first time period starts at a moment when the display unit displays thereon the M objects and ends at a moment when the first input operation is acquired;

determine an operation habit of a user at least according to a type of the first input operation; and

update a collection composed of weight values of the N objects based on the operation habit of the user and the L.

Alternatively, the type of the first input operation is a voice input type, and the processor 84 is also configured to judge whether the execution object is one of the L objects;

If the judgment result is yes, determine that operation habit of the user is a voice input habit according to the voice input type and the judgment result;

or, if the judgment result is no, determine that operation habit of the user is a non-voice input habit according to the voice input type and the judgment result.

Alternatively, the type of the first input operation is a voice input type, and the L is not equal to M; the processor 84 is particularly configured to determine that user operation habit is a non-voice input habit according to the voice input type and that the L is not equal to M.

Alternatively, the type of the first input operation is a non-voice input type; the processor 84 is particularly configured to determine that user operation habit is the non-voice input habit according to the non-voice input type.

Alternatively, if the operation habit of the user is a non-voice input habit, the processor 84 is particularly configured to decrease the L weight values corresponding to the L objects.

Alternatively, if the operation habit of the user is a voice input habit, the processor 84 is particularly configured to increase the L weight values corresponding to the L objects in the case the N objects are objects that are frequently used.

According to the electronic device provided by the disclosure, the electronic device includes N objects and displays thereon M objects; after the first input operation is responded to with the execution object, the operation habit of the user is determined at least according to the type of the first input operation, and the collection composed of weight values of N objects is updated based on the operation habit of the user and the L, wherein L is the number of objects displayed on the display unit from the moment when the display unit displays thereon M objects to the moment when the first input operation is acquired. The updated collection may be used in the process of finding the execution object by a voice input operation the next time, thus improving a match degree between a recognition result of a voice recognition engine and a result required by the user, and thus improving the user experience.

### Seventh Embodiment

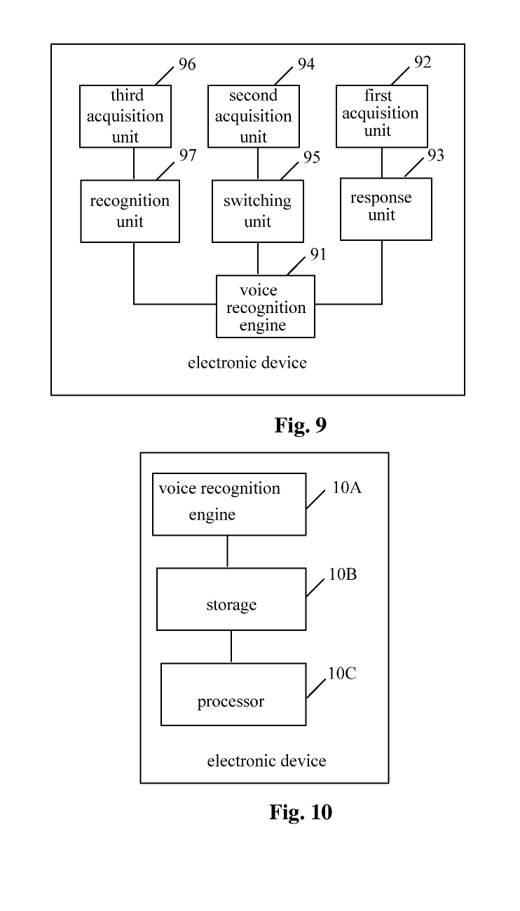

Referring to FIG. 9, an electronic device is provided according to the embodiment of the disclosure to execute a method for processing information shown in FIG. 6, the electronic device includes an voice recognition engine 91, and the electronic device has N objects, and the N is an integer greater than or equal to 1; the electronic device also includes:

a first acquisition unit 92, configured to acquire a first input operation; the first input operation involves M objects, and the M is an integer greater than or equal to 1 and less than N;

a response unit 93, configured to respond to the first input operation with the M objects;

a second acquisition unit 94, configured to acquire a triggering operation;

a switching unit 95, configured to switch the voice recognition engine from a low power consumption state to an operating state based on the triggering operation;

a third acquisition unit 96, configured to acquire a voice input; and

a recognition unit 97, configured to recognize the voice input based on the voice recognition engine to obtain the recognition result;

where in the process of recognizing the voice input based on the voice recognition engine, the remaining N-M objects are recognized and matched with the voice input taking precedence over the M objects.

An electronic device provided according to the embodiment of the disclosure includes the display unit, the voice recognition engine and the N objects, the electronic device is configured to acquire a first input operation and respond to the first input operation with M objects, and after a voice input is acquired recognize the voice input based on the voice recognition engine to obtain the recognition result; where in the process of recognizing the voice input based on the voice recognition engine, the remaining N-M objects are recognized and matched with the voice input taking precedence over the M objects. The M objects can be acquired by the user when M objects is used to respond to the firsts input operation, if the user also make voice input after recognizing the M objects, which indicates that there is no objects required by the user in the M objects, so it can be known the objects required by the user is in the N-M objects, therefore, the objects which is not required by the user are recognized and matched with the voice input taking precedence over the objects have been required, which may acquire the recognition result quickly and thereby improve the user experience.

### Eighth Embodiment

Referring to FIG. 10, an electronic device is provided according to the embodiment of the disclosure to execute a method for processing information shown in FIG. 6, the electronic device includes an voice recognition engine 10A, and the electronic device has N objects, and N is an integer greater than or equal to 1, the electronic device also includes a storage 10B and a processor 10C, wherein

the storage 10B is configured to store a set of codes which is used to control the processor 10C to perform the following actions:

acquire a first input operation; the first input operation involves M objects, and M is an integer greater than or equal to 1 and less than N;

respond to the first input operation based on the M objects;

acquire a triggering operation;

switch the voice recognition engine from a low power consumption state to an operating state;

acquire a voice input;

recognize the voice input based on the voice recognition engine to obtain the recognition result;

wherein in the process of recognizing the voice input based on the voice recognition engine, the remaining N-M objects are recognized and matched with the voice input taking precedence over the M objects.

An electronic device provided according to the embodiment of the disclosure includes the display unit, the voice recognition engine and the N objects, the electronic device is configured to acquire a first input operation and respond to the first input operation with M objects, and after a voice input is acquired recognize the voice input based on the voice recognition engine to obtain the recognition result; wherein in the process of recognizing the voice input based on the voice recognition engine, the remaining N-M objects are recognized and matched with the voice input taking precedence over the M objects. The M objects can be acquired by the user when M objects is used to respond to the firsts input operation, if the user also make voice input after recognizing the M objects, which indicates that there is no objects required by the user in the M objects, so it can be known the objects required by the user in the N-M objects, therefore, the objects which is not required by the user are recognized and matched with the voice input taking precedence over the objects have been required, which may acquire the recognition result quickly and thereby improve the user experience.

An electronic device provided according to the embodiment of the disclosure includes the display unit, the voice recognition engine and the N objects, the electronic device is configured to acquire a first input operation and respond to the first input operation with M objects, and after a voice input is acquired recognize the voice input based on the voice recognition engine to obtain the recognition result; wherein in the process of recognizing the voice input based on the voice recognition engine, the remaining N-M objects are recognized and matched with the voice input taking precedence over the M objects. The M objects can be acquired by the user when M objects is used to respond to the firsts input operation, if the user also make voice input after recognizing the M objects, which indicates that there is no objects required by the user in the M objects, so it can be known the objects required by the user in the N-M objects, therefore, the objects which is not required by the user are recognized and matched with the voice input taking precedence over the objects have been required, which may acquire the recognition result quickly and thereby improve the user experience.

The above descriptions are just specific embodiments of the disclosure, which should not be interpreted as limiting the disclosure. Any alternations and modifications made, by those skilled in the art, to the embodiments above according to the technical essential of the disclosure without deviation from the scope of the disclosure should fall within the scope of protection of the disclosure. Therefore, the scope of protection of the disclosure is limited by the scope of protection by the claims.

1. An information processing method, applied to an electronic device, wherein the electronic device comprises a display unit, a voice recognition engine and N objects, N≧1, the N is an integer, each object corresponds to a weight value, the weight value of each object is used to indicate a weight of the object in a search space of the voice recognition engine, the display unit displays thereon M objects, 1≦M<N, the M is an integer, the information processing method comprises:
acquiring a first input operation;
acquiring an execution object according to the first input operation;
responding to the first input operation with the execution object;
after the first input operation is responded to, determining L objects that have been displayed by the display unit in a first time period, wherein M≦L≦N, the L is an integer, the first time period starts at a moment when the display unit displays thereon the M objects and ends at a moment when the first input operation is acquired;
determining an operation habit of a user at least according to a type of the first input operation; and
updating a collection composed of weight values of the N objects based on the operation habit of the user and the L.

2. The information processing method according to claim 1, wherein the type of the first input operation is a voice input type, the information processing method further comprises:
judging whether the execution object is one of the L objects;
the determining an operation habit of a user at least according to a type of the first input operation comprises:
if the judgment result indicates that the execution object is one of the L objects, determining that the operation habit of the user is a voice input habit, according to the voice input type and the judgment result; or
if the judgment result indicates that the execution object is not one of the L objects, determining that the operation habit of the user is a non-voice input habit, according to the voice input type and the judgment result.

3. The information processing method according to claim 1, wherein the type of the first input operation is a voice input type and the L is not equal to the M, the determining an operation habit of a user at least according to a type of the first input operation comprises:
determining that the operation habit of the user is a non-voice input habit, according to the voice input type and the fact that the L is not equal to the M.

4. The information processing method according to claim 1, wherein the type of the first input operation is a non-voice input type, the determining an operation habit of a user at least according to a type of the first input operation comprises:
determining that the operation habit of the user is a non-voice input habit, according to the non-voice input type.

5. The information processing method according to claim 1, wherein the operation habit of the user is a non-voice input habit, the updating a collection composed of weight values of the N objects based on the operation habit of the user and the L comprises:
decreasing L weight values corresponding to the L objects.

6. The information processing method according to claim 1, wherein the operation habit of the user is a voice input habit, the updating a collection composed of weight values of the N objects based on the operation habit of the user and the L comprises:
increasing L weight values corresponding to the L objects in the case that the N objects are objects that are frequently used.

7. An information processing method, applied to an electronic device, wherein the electronic device comprises a voice recognition engine, the electronic device have N objects, the N is an integer greater than or equal to 1, the information processing method comprises:
acquiring a first input operation, wherein the first input operation involves M objects, the M is an integer greater than or equal to 1 and less than N;
responding to the first input operation based on the M objects;
acquiring a triggering operation;
switching the voice recognition engine from a low power consumption state to an operating state based on the triggering operation;
acquiring a voice input; and
recognizing the voice input based on the voice recognition engine to obtain a recognition result,
where in the process of recognizing the voice input based on the voice recognition engine, the remaining N-M objects are recognized and matched with the voice input taking precedence over the M objects.

8. An electronic device, wherein the electronic device comprises a display unit, a voice recognition engine and N objects, N≧1, the N is an integer, each object corresponds to a weight value, the weight value of each object is used to indicate a weight of the object in a search space of the voice recognition engine, the display unit displays thereon M objects, 1≦M<N, the M is an integer, the electronic device comprises:
a first acquisition unit, configured to acquire a first input operation;
a second acquisition unit, configured to acquire an execution object according to the first input operation;
a response unit, configured to respond to the first input operation with the execution object;
a history object determination unit, configured to, after the first input operation is responded to, determine L objects that have been displayed by the display unit in a first time period, wherein M≦L≦N, the L is an integer, the first time period starts at a moment when the display unit displays thereon the M objects and ends at a moment when the first input operation is acquired;
a user operation habit determination unit, configured to determine an operation habit of a user at least according to a type of the first input operation; and
an updating unit, configured to update a collection composed of weight values of the N objects based on the operation habit of the user and the L.

9. The electronic device according to claim 8, wherein the type of the first input operation is a voice input type, the electronic device further comprises:
a judgment unit, configured to judge whether the execution object is one of the L objects, the user operation habit determination unit is configured to:
if the judgment result indicates that the execution object is one of the L objects, determine that the operation habit of the user is a voice input habit according to the voice input type and the judgment result; or
if the judgment result indicates that the execution object is not one of the L objects, determine that the operation habit of the user is a non-voice input habit according to the voice input type and the judgment result.

10. The electronic device according to claim 8, wherein the type of the first input operation is a voice input type and the L is not equal to the M,
the user operation habit determination unit is configured to determine that the operation habit of the user is a non-voice input habit according to the voice input type and the fact that the L is not equal to the M.

11. The electronic device according to claim 8, wherein the type of the first input operation is a non-voice input type,
the user operation habit determination unit is configured to determine that the operation habit of the user is a non-voice input habit according to the non-voice input type.

12. The electronic device according to claim 8, wherein the operation habit of the user is a non-voice input habit, the updating unit is configured to decrease L weight values corresponding to the L objects.

13. The electronic device according to claim 8, wherein the operation habit of the user is a voice input habit, the updating unit is configured to increase L weight values corresponding to the L objects in the case that the N objects are objects that are frequently used.
